(19) United States
(12) Patent Application Publication
(10) Pub. No.: US 2008/0087495 A1
(43) Pub. Date: Apr. 17, 2008

(54) System For Saving And Evacuating Persons, Which Is Applied To Buildings

(76) Inventor: Jose Maria Gonzalez Ordonez, Malaga (ES)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(21) Appl. No.: 11/719,824

(22) PCT Filed: Oct. 31, 2005
(86) PCT No.: PCT/ES05/00587

§ 371 Date: May 22, 2007

(30) Foreign Application Priority Data
Nov. 22, 2004 (ES) P200402815

(51) Int. Cl. A62B 1/20

(52) U.S. Cl. 182/11

(57) ABSTRACT

The invention relates to a system which is used for saving and evacuating persons and which is applied to buildings. The system is characterised in that it comprises cables (10 and 11) which are formed respectively by smaller interconnected cables (12 and 12′) and which are positioned in a spiral configuration with a calculated pitch. The system also includes a spring hook (1) which is coupled to the spiral surface and which comprises: at one end, a zone providing access (2) to the interior and a transverse projection (3); and, at the opposing end, a zone (4) which is narrower in relation to the first end. According to the invention, a lifting piece (20) is coupled to the spring hook (1) and applied to a harness (21) worn by the user (30). One end of the cable assembly (10 and 11) is fixed to a motor reducer (23) by means of a tension member (22), while, optionally, the opposing end of the assembly is fixed to a lifting body (42) that extends from the lower part of a support (40) that is attached transversely to the facade of a building (41). The support (42) is equipped with a zone (44) for fixing the upper end of the cables and, optionally, a vertical projection (43) from which a guide cable (13) extends. Said guide cable (13) is coupled to the spring hook (1) to enable the harness (21) user (30) to move vertically such as to eliminate the rotation effect. The user or person to be evacuated can descend along a fixed cable that does not turn, rotating the user thereof. In addition, the system includes a braking unit which can be fixed to the upper or lower part of the building or incorporated at the time of the incident, said unit comprising automatic mechanisms.

### OBJECT OF THE INVENTION

The present descriptive report refers to a Patent of Invention application for a rescue and evacuation system that can be implemented in buildings and is intended to save the lives of people trapped in buildings and other type of structures in a safe, quick, efficient and economic manner, while also making existing buildings safer and giving emergency rescue teams such as fire-fighters and enforcement agencies personnel with new tools that facilitate evacuation of the persons trapped inside buildings.

Additionally, this system object of the invention can be also installed in ships, oil extraction platforms, alpine sites, etc. substantially increasing the safety of the site.

### FIELD OF THE INVENTION

The present invention is applicable in the field of manufacturing of devices, systems and auxiliary elements required in the rescue and evacuation of persons.

### BACKGROUND OF THE INVENTION

Amongst the current systems used for rescue and evacuation of people from buildings, Patent 532907 authored by the same applicant in 1984 describes one such system. This patent refers to “improvements in rescue systems used in evacuating people trapped in burning buildings”. In the meantime, time and improvements to the existing system have rendered it obsolete as it will be described in the present document.

The same applicant incorporated numerous improvements to said rescue and evacuation system that are contained in patent P200201406 dated July 14^{th} of 2002. These improvements, while still valid, will be substantially improved. The present application for a patent of invention will lower the costs of the procedure while contributing new and safer solutions for all involved.

We interviewed fire-fighters, business men, and public and private institutions related to the security industry during the 2004 International Security, Safety and Fire Trade Fair (SICUR). The results from this field survey confirmed that as of today the system we propose does not exist in the market, as well as the still existing need of better security measures for severe disaster events.

During the same International Trade Fair (SICUR) of 2004, we were fortunate to receive suggestions on the subject that we have translated into specific technical solutions. We will remark on one observation made by numerous parties regarding the hydro-aerodynamic braking system patented in 2002: “the system continues to be efficacious, but we have been told that people rescued with this system may suffer psychological trauma because they descend in what is practically a free fall and are abruptly decelerated.” In fact, we have been asked to “moderate the downward travelling speed of the potential victims that need to be evacuated.”

Since February of 2004 to the end of October of 2004 we have been working on this issue. The solution we have found for this problem will be described below. Both the patents submitted in 1984 and 2002 offered a deliberately fast evacuation of individuals to separate them quickly from the burning buildings. This was achieved by working with small inclinations in the descending cables, which forced us to place the braking unit at a considerable distance from the affected building (due to physical space considerations), while it subjected the carabiner of the harness used in the downward travelling path, or descent, to intense friction stress on the evacuation cable. The new arrangement will achieve the following improvements:
1. Moderate the downward speed of travelling of the evacuated persons down the cable at the operator's will. That is, the rescuer will be able to control the speed of descent and make the device go faster or slower as needed, and even stop the process if needed.
2. The slopes of the descending cable will be much greater, possibly having an inclination angle of about 80°, although it can also be less pronounced, that is, we can use the inclination angle that is most suitable to the circumstances.
3. Having the flexibility to use the inclination we desire makes this system ideal to be deployed outside of the building by means of TELESCOPIC CRANES, although for obvious security considerations it is advisable that the system is already in place as a precautionary safety measure.
4. The friction stress sustained by cable and caused by the carabiner of the harness is kept to a minimum; we can even say there is no longer any friction stress. The wearing out of the cable and the systems already patented (in 1984 and 2002 respectively) have been almost completely eliminated with this new proposed system.
5. The new system is considerably cheaper and easier to handle than the previous 1984 and 2002 systems. We have eliminated the turbines—by substituting them with very simple, cheap and easy to use braking systems (electric motor with reducer gear, manual operation and braking system).
6. The volume occupied by the braking system, as compared with the previous systems, is minimal.

### DESCRIPTION OF THE INVENTION

The present person rescue and evacuation system that can be implemented in buildings proposed by the present invention comprises installing, or deploying—once the emergency event has occurred by means of telescopic cranes, helicopters or other procedures—a series of descending or evacuation cables and a certain number of harnesses in each dwelling that will vary according to the characteristics of the building, and that incorporate a braking unit that may belong to the building and be already installed in the external side of the building, or be brought at the time of the rescue operation.

The braking unit may be a mobile unit, in which case it will be brought by the specialized emergency rescue personnel—such as the fire-fighter brigade, civil protection teams, other security bodies and authorized personnel, etc.—or be already installed in the building as a security measure.

More specifically, the person rescue and evacuation system that can be implemented in buildings that is the object of the invention comprises a cable that is the sum of several braided independent cables—preferably having all the same diameter—that form a HELIX or coil that will work to all effects as an ENDLESS SCREW by rotating on its longitudinal axis at the speed (revolutions) we wish it to gyrate. The immediate results of this configuration are as follows:
We can control and manage the revolutions at which the cable rotates and the size of the pitch or the helix by making it shorter or longer, which serves to control de downward travelling speed of the person on the descent cable being evacuated.
The friction of the harness against the cable is minimal, since it is going to gyrate at a slow speed (and always at a controlled speed), and therefore the friction on the carabiner while the person is descending down the cable (heat production) is very low (technically insignificant).
The descending cable, which helix or coil is made of several individual cables (preferably two) must work with the stress that allows rotating the cable without causing undesired oscillations or waves. This effect can be avoided by working with large inclinations or by tensing the cable and minimizing the catenary that will form.
Once a person enters in the “helix of the descending cable and has rotated only half of the period of a revolution (or half a turn of the helix), another person can already be fitted to the cable to be evacuated without contacting the person ahead. An event that is physically impossible since it is prevented by the turn of the helix itself”. This means that if we estimate a helix pitch of a meter, for instance, the persons to evacuate will be separated at least by a distance of half a meter.” We can attain a greater or lesser advance in the downwards travel of the person evacuated by varying the turn of the helix to equal the number of revolutions of the cable (faster or slower speed, even if we stop the rotation, revolutions of the cable we stop the forward movement and break the travelling downwards path of the person to 0).
   In short, with the proposed arrangement we guaranty there is a spacing distance between the individuals being evacuated. It is physically impossible for a person to be overcome by a person of a greater weight going behind the first one, since if all individuals are going to descend at the same speed and distance, regardless or their weight and physical condition (conscious, unconscious, injured, etc.).

This system may be either already installed in the building or it can be brought to the site at the time of the emergency. Current telescopic crane technology allows evacuating out of buildings individuals that have been trapped at heights of over 20 storeys. (Some high tonnage cranes have booms that can extend above 30 storeys). This type of boom crane can “extract” human beings from their bedrooms or other living or working spaces in their homes or at their work sites where they have become trapped.

In the instance of the system already being installed at the building or structure (such as a ship, oil platform, etc.) the evacuation cable has to be anchored to a structural element such as a beam or pillar that can ensure the correct operation of the present invention while the structure or building is still standing.

The end of the cable has to be able to rotate freely to be able to rotate around its longitudinal axis, while the other end that is going to be secured to the brake unit or arrival point has to also allow, like the anchoring point to the building, the cable to rotate (revolutions).

Another option is to leave the cable anchored to the building and control the rotation of the cable by a gear reducer mechanism located on its upper part and leave the bottom end, that is the end located at street or ground level, free.

A further option, that has been tested in the trial runs, is to leave the cable secured with a perfectly plumbed 90° vertical fall and let the person trying the invention, that is, the person being evacuated out of the building or similar structure, by using the present invention, in a gyrating position, that is, it is the person, and not the cable, that rotates as it travels downwards.

The descent cable, if already installed in a building, may be half-deployed or completely rolled up, waiting to be unrolled or deployed. The first option, half-unrolled, is faster and may be ready to operate in a few seconds, although in the long run rust and dirt may form on the surface of the cable due to being exposed to the elements.

The braking unit may be operated either manually or mechanically, and revolutions can be sent to the evacuation cable, just as they can be stopped (brakes), proceeding to install motors that are usually electronic and/or mechanical means such as turn handles, turning axle, levers, etc., intended to control and operate the present invention according to the particular needs or contingency at hand.

Another option, mentioned before, is to use a fixed helicoidal cable on which revolutions may not be generated, and in this case it is the individual being evacuated and held by the harness the one that rotates down driven by his or her own weight.

This rescue and evacuation system requires that there are braking units installed in both the mobile and the permanent onsite facilities. For the first case, a simple electric motor provided with a gear reducer mechanism serves to control and operate perfectly this particular rescue and evacuation arrangement , always considering that in case of mechanical breakdown or other type of failure (such as lack of electric power supply), there has to be a manual mechanism operative and in place to work the system. It seems reasonable, a priori, to think that any system brought by the fire-fighters, or any permanently maintained system (such as facilities installed in malls, official buildings, etc.) will operate correctly, and that an electric or an explosion motor (such as the engine of fire-fighting engines that is usually used for the rotating axle provided by the truck) can also operate optimally, while facilities installed in regular buildings or nearby that may suffer from infrequent or no maintenance will require basic mechanical devices that are nevertheless equally operative (turn handle, lever, gear teeth, disk brakes, etc.) that require little or no maintenance and are ready for operation on demand.

In the non-rotating cable option, only the harness is necessary, more precisely its carabiner element, to descend rotating around the length of the cable that is perpendicular to the floor.

The essential principle and the innovation of this arrangement, as mentioned above, is that it USES THE EVACUATION CABLE AS AN ENDLESS SCREW. When used in this manner the cable is no longer made of an individual cable, requiring at the least, two cables that will be braided together to form the helix configuration that will allow us to control the entire process of rescue and evacuation.

To obtain the ENDLESS SCREW effect, we can associate several cables. In principle we can have N cables, where N is a number greater than 1 (more than one cable) and lower than 6 (six being the upper limit), since a helix formed by more than 6 cables has a round profile that will pose an obstacle to obtain the desired endless screw effect.

We consider the most efficacious arrangement is obtained using two cables, since it is the arrangement that has a greater CABLE DIAMETER/HELIX DIAMETER ratio: ½. For a cable having 10 mm diameter, for instance, we obtain a helix thickness of 20 mm, which will give as the maximum effectiveness in terms of cable rotation (revolution) function.

Helixes formed by three cables are effective, but they present more problems in terms of designing and making the carabiner that is attached to the descending harness, while when designing and building the carabiner attached to the harness used in the downward travel path, a consideration is that the ratio of cable diameter to helix diameter decreases progressively, translating into a lesser efficacy of the system.

It should be noted that the cable that has been found to be most suitable for the present invention is made by two single cables braided together and configuring the first turn or pitch of the helix or “first turn of the screw”, and that depending on the length of the “turn” the same number of revolutions will lend the rotation of the cable more or less descending speed.

The physical and technical principles on which the system is based are simple and basic:
A. The weight of the individual that has to use this system is the factor that will activate the operation of the system.
B. The anchored cable with free ends will tend to rotate due to the torque effect imparted by the individual that is descending along it: “the movement forward of the individual while falling is transmitted to the cable as a torque effort, so as the person descends the cable rotates.”
C. Preferably at the arrival point, that is, at the braking unit is where the number of revolutions is going to be determined, automatically or manually, either by braking as it is the case when many individuals are going down the cable at the same time, imparting a great deal of torque effort to the cable, or by increasing the number of revolutions because the individual going down may be too small (such as in the case of a baby) to impart sufficient weight to activate the system of the present invention, that is, said individual lacks the required inertia. In the case of the non-rotating cable it is the individual that descends as it rotates on the cable, regardless of his or her body weight, physical condition, etc.
D. The following are the three main areas of the system:
   1. The area of connection of the system to the building. It has sufficient room at the end to be able to comfortably hook the carabiner to the cable. This area has a smooth tube for the cable to go through and also serves as access point for the person to be evacuated to the helix of the cable automatically without being run over.
   2. The descending area, having a greater or lesser length depending of the height of the building on which the helix is installed and the revolutions of the cable, will determine the downward travelling speed of the individual, and
   3. The arrival area where we will place a tube without a helix (similar to the upper staring area where the mechanism is hooked) that allows the rotation of the entire arrangement but that makes easier for the rescued person to become detached from the arrangement (the opposite situation from the arrival area). This area may be free provided the angle of descent is of 90° (plumbed descent) in which case we can eliminate this area of arrival and the braking unit.

In the case of installing the non-rotating cable, and in order for having the person rotate as it descends down the cable, the braking unit is eliminated, and only the descent cable and the harness with its corresponding carabiner attached to the cable's helix are required to effect the descent operation.
E. It is at the arrival area where, in principle, the braking unit and the dragging motor used to moderate the speed of descent (+/−) of the entire arrangement are located. It must be noted that there is the option of non-rotating cable perpendicular to the floor, that is, a perfectly vertical cable set at a 90° angle from the ground level that does not require any additional mechanism to operate, except the descent harness, that is, the carabiner system that attaches to the cable.

Rescue systems based on gear reducing mechanisms have been shown to be highly efficacious, although other mechanical options are also available (disk brakes, handles, etc.). This system to brake or moderate the speed of descent incorporated to the present rescue and evacuation system (control of the revolutions or number of turns of the cable) can also be located on the upper part of the device.

### DESCRIPTION OF THE DRAWINGS

The following figure drawings have been included as graphically aids to understand the characteristics of the present invention, and are an integral part of this descriptive report. A set of plan drawings has also been included for the same purposes All drawings are included for merely illustrative, and not limiting, character:

FIG. 1 Shows a side view of the carabiner used in the present invention for the rescue and evacuation of people applicable to buildings.

FIG. 2 shows a perspective view of the multiple cable arrangement that braided in a helicoidal shape result in the possibility for the person being evacuated in using them to descend in a safe and secure manner.

FIG. 3 Shows a perspective view of the elements illustrated in FIGS. 1 and 2 emphasizing the determining affixing mechanism of the harness.

FIG. 4 Shows a perspective view of the invention secured by its lower end to a gear reducing motor element incorporated to the rear part of an automobile. It also shows the harness that carries the person to be evacuated.

FIG. 5 Shows a view of the present invention at the point of attachment to a building by a supporting element affixed to said building, implemented with a guide cable that helps in the descent of the rescue person. This guide cable avoids unpleasant rotation, and can be eliminated in the version in which the cable is perpendicular to the ground level and it is the person and not the cable that rotates in its path downwards propelled by its own weight, eliminating the need for the braking unit that actuates on the cable's rotation.

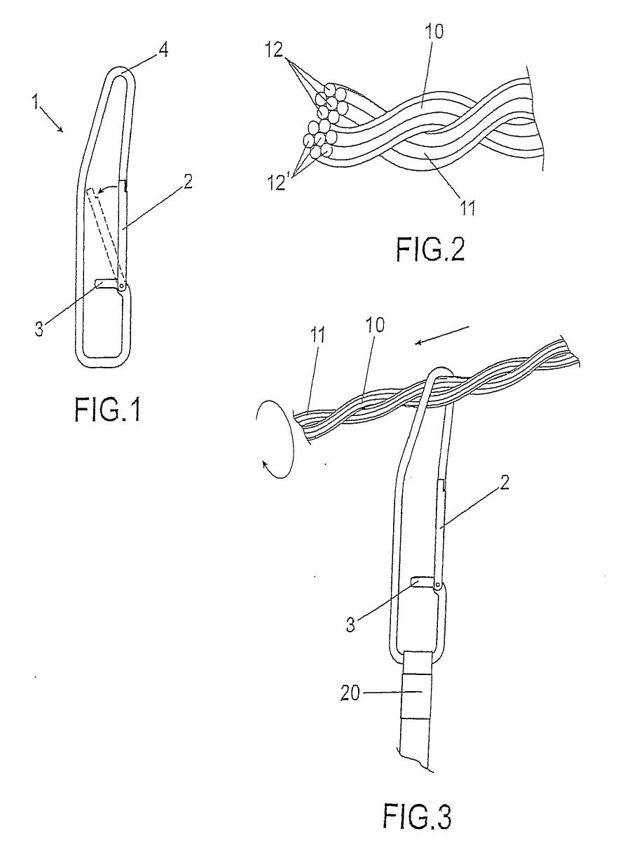

### PREFERRED EMBODIMENT OF THE INVENTION

The figures described above show how the system for rescue and evacuation for people applicable to buildings, and that can evidently be used in any other structure, such as a ship or similar, is constituted by a set of cables (10) and (11) formed themselves by cables (12) and (12′) helicoidally arranged, as well as a carabiner (1) that has an access or opening area (2) and a transversal inward projection (3) that attaches and fits over the cables (10) and (11) and the entire structure has one end (4) narrower than its opposite end.

Looking at FIG. 3, it can be observed how cables (10) and (11) hold the carabiner (1) and how from the wider end of the carabiner hangs a strip (20) that serves to secure it to the harness (21) that supports the body (30) of the person being evacuated, and the set of helicoidally arranged cables (10) and (11) are topped by a gear reducing motor (23), a tensor element (22) and the corresponding hooking area.

FIG. 5 shows how the set of cables (11) and (10) are affixed by their upper end (44) to an element (42) that is projected out from another body (40) placed transversally to the facade of a building (41) and having an additional cable attached (13) to which the narrow end of the carabiner (4) is also incorporated, so said cable (13) acts as a guiding cable as it exits a supporting element (43) of the area (42) of the supporting element (40).

It should be noted that the descent cable is formed by two cables (10) and (11) that themselves are made by a plurality of cables (12) and (12′) respectively, that by having been braided together form the helix that when rotating (depending on the turn pitch) will cause the descent of the persons to be evacuated. Each turn (1 revolution) translates into a given downwardly traversed distance (length traversed equals the pitch of the turn of the helix). The detail view of the carabiner clarifies the operation and the principle on which the present evacuation system is based.

The width of the upper end of the carabiner is slightly larger than the diameter of the cable that forms the helix (i.e., for a cable having a 10 mm diameter said upper end of the carabiner must have an 11 mm diameter, or 10 to 15% wider than the carabiner's width). Since the helix is formed by two cables that rotate, it will go from a minimum of 10 mm (perpendicular to the floor) to a maximum of 20 mm, when the helix is parallel to the floor. Since the carabiner's diameter is only 11 mm, the clearance or tolerance of its upper part is equal or greater than 1 mm, which allows descending down the cable without difficulties (10 mm diameter), it “fits by gravity” on the helix of the cable without difficulties (1 mm tolerance). Once hooked to the cable it can only go down at the speed the revolutions of the cable permit.

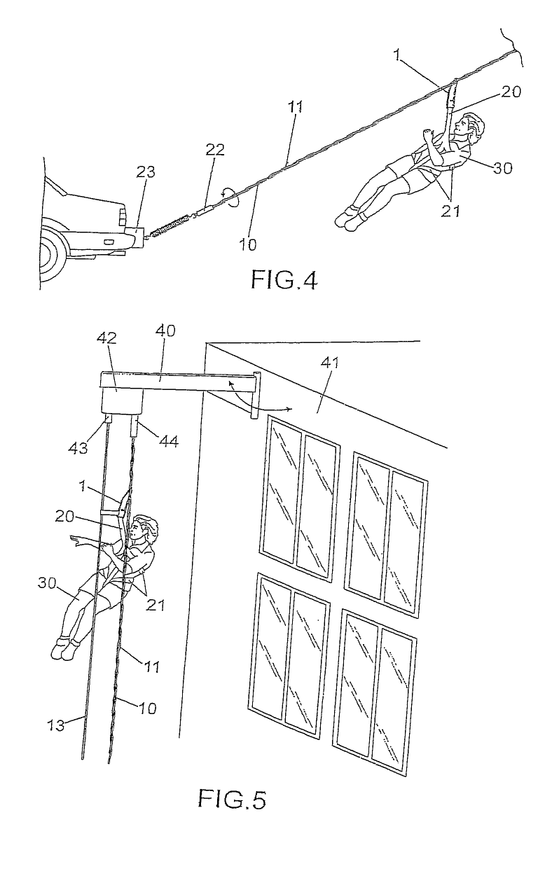

FIG. 4 shows how a person (30) is evacuated from a building—in this particular instance the braking mechanism is attached to an automobile (mobile breaking unit), but it could also be attached to a post, a wall or any other element or object that could serve to anchor the descent cable to the braking unit.

FIG. 5 shows how the invention has a cable that falls perfectly vertical (plumb fall), that is, it is perpendicular to the ground. It also shows an upper driving motor intended for the proprietary use of a residence. The installation can be done in the inner or outer facade.

As it can be seen in FIG. 5, the present invention allows installing a guide (13) that enables moving the entire arrangement, that is, the downshifting motor, cable, person to be evacuated, etc., across the facade (parallel to that side of the building). This arrangement allows us to evacuate individuals from any point of the facade bringing the descent cable towards said person by guiding it on the upper guiding element.

1. System intended for the rescue and evacuation of people applicable to buildings, and characterized in that it is formed by cables (10) and (11) that are respectively formed by other cables joined together (12) and (12′) and in which said cables (10) and (11) are arranged in a helicoidal shape, having a carabiner (1) that attaches on to the helicoidal surface formed by cables (10) and (11) that are constituted by a plurality of cables joined together (12) and (12′) respectively, the carabiner (1) presenting an access zone (2) opening to its inside, a transversal projection (3) and one end of narrower width (4) than its opposite end, affixed to the carabiner(1) there is a tying piece (20) that joins it to a harness (21) inside of which is placed the user (30), the set of cables (10) and (11) is secured on one of its ends to a downshifting motor (23) by a tensor (22) and, optionally, on the opposite end, set of cables (10) and (11) is secured to a supporting body (42) that emerges from the lower part of a support (40) that is located transversally-wise on the facade of a building (41), and supporting body (42) presenting an area (44) for affixing the upper end of the cables and having, optionally, a vertical projection (43) from which exits a guide cable (13) that will be attached to the carabiner (1) to guide the vertical travelling path of the harness (21) user (30).

2. System for rescue and evacuation of people applicable to buildings according to claim 1, characterized in that the set of cables (10) and (11) configure a helix having a calculated turning pitch.

3. System for rescue and evacuation of people applicable to buildings according to claim 1, characterized in that the ends of the cable formed by elements (11) and (11′) are unattached and can rotate freely, by mechanical actuation, by the weight of the person being evacuated, or manually actuated when it is desirable to control the descent of the person being evacuated.

4. System for rescue and evacuation of people applicable to buildings according to claim 1, characterized in that it incorporates a braking unit that can be either already installed in the upper or inner part of the building, or can be brought to the site at the time required by the emergency event. This braking unit is fit with automatic mechanisms.

5. System for rescue and evacuation of people applicable to buildings according to claim 1, characterized in that the carabiner (1) can be simultaneously affixed to two descent cables that are perpendicular to the ground, specifically the guiding cable (13) and the helicoidally arranged cabled (11) and (10), eliminating the rotating effect.

6. System for rescue and evacuation of people applicable to buildings according to claim 1, characterized in that the user or person to be evacuated can descend on a fixed, non-rotating cable while said person descends describing a rotating motion.

7. System for rescue and evacuation of people applicable to buildings according to claim 2, characterized in that the ends of the cable formed by elements (11) and (11′) are unattached and can rotate freely, by mechanical actuation, by the weight of the person being evacuated, or manually actuated when it is desirable to control the descent of the person being evacuated.
